(19) United States
(12) Patent Application Publication
(10) Pub. No.: US 2004/0222547 A1
(43) Pub. Date: Nov. 11, 2004

(54) Method and arrangement when forming a mat of particles

(76) Inventors: Ulrika Backlund, Sundsvall (SE); Patrik Pettersson, Bonassund (SE); Leif Andersson, Kvisleby (SE); Sven-Ingvar Thorbjornsson, Karlstad (SE)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/486,704

(22) PCT Filed: Aug. 15, 2002
(86) PCT No.: PCT/SE02/01460

(30) Foreign Application Priority Data
Aug. 16, 2001 (SE) 0102742.4

(51) Int. Cl. B27N 3/14

(52) U.S. Cl. 264/113; 264/109; 425/81.1; 425/83.1

(57) ABSTRACT

Methods for forming particle mat from lignocellulose-containing particles in the production of sheet material are disclosed including providing a flow of lignocellulose-containing particles from a supply source at an elevated height, depositing the flow of lignocellulose-containing particles from that height by means of gravity onto a forming belt at a lower height, and retarding the flow of lignocellulose-containing particles as it passes from the upper height to the lower height. Apparatus for carrying out the method is also disclosed.

### FIELD OF INVENTION

The present invention relates to a method of forming a particle mat which is intended to form one or more sheets or boards of lignocellulose-containing material, wherein particles are fed down gravitationally onto a forming belt from a particle supply source situated at a greater height than the forming belt.

More particularly, the present invention relates to apparatus for carrying out the above method, said apparatus comprising a particle supply source and a particle receiving forming belt, wherein the particle supply source is situated at a greater height than the forming belt so that particles can be delivered from the supply source to the forming belt under the force of gravity.

Still more particularly, the present invention relates to a method and to a plant for producing sheets or boards of lignocellulose-containing material.

### BACKGROUND OF THE INVENTION

A conventional method of producing sheets from lignocellulose-containing material is to first disintegrate the raw material into small particles or fiber bundles, and to then dry and gum the particles. The particles are then formed into a mat in a continuous forming process, and the mat is pressed into sheets or boards in a hot press under pressure. The mat is compressed in the press process, and the gum applied hardens and/or cures as heat is applied from the press. The lignocellulose-containing raw material may be mixed with other raw material, such as plastic, wastepaper, fiberglass, finely divided minerals, etc. The press process may be either continuous or discontinuous. In the case of a continuous press process, the continuously produced board is divided downstream of the continuous press, into lengths that can be handled in practice. In the case of a discontinuous pressing process, the mat is divided into appropriate lengths prior to pressing the mat.

It is essential during board manufacture that the board has homogenous properties over its entire surface. These properties include, among other things, thickness, internal bond strength or z-strength, bending strength, tensile strength, coloring properties, etc. All of these properties are directly dependent on the density of the board; i.e. the raw material per unit of volume, the more bonding points that occur during the press process the higher the values of the aforesaid strength properties and the denser the board with subsequent lower absorption. This is a well-known fact in the particle board industry and the MDF industry, for instance. It is therefore essential that forming of the mat, i.e. the accuracy in which the sized raw material is formed into a mat, is effected as homogeneously as possible, in both the longitudinal and transverse directions of the mat.

The function of the forming machine or the forming station is thus of decisive significance to the quality of the sheet or board. A typical forming station design comprises a metering bin that feeds particles, fiber or chip material continuously down onto a forming belt, which transports the mat to a hot press. The infeed, handling and outfeed of the particles from the metering bin is effected in a known manner such as to distribute the flow of material onto the forming belt. The difficulty with this process resides in distributing the material across and along the forming belt as uniformly as possible. Air movements are generated in the forming station, as a result of the flow of fibers falling down onto the forming belt from the metering bin. These air movements are difficult to control and interfere with the smoothness in depositing the material onto the forming belt. As a result of the fibers falling onto the forming belt, air movements occur in the form of air that is entrained by an ejector effect and also in the form of air that is displaced as the material “thuds” down onto the belt.

One object of the present invention is to avoid, or at least to reduce, the problem of deficient mat homogeneity caused by the air currents generated by movement of the particles, as described above.

### SUMMARY OF THE INVENTION

In accordance with the present invention, these and other objects have now been realized by the invention of a method of forming a particle mat from a flow of lignocellulose-containing particles in the production of sheets of lignocellulose-containing material, the method comprising providing the flow of lignocellulose-containing particles from a supply source at a predetermined height, depositing the flow of lignocellulose-containing particles from the predetermined height by means of gravity onto a forming belt at a location below the predetermined height, and retarding the flow of lignocellulose-containing particles from the predetermined height to the location below the predetermined height. Preferably, the retarding of the flow of lignocellulose-containing particles comprises providing a retarding surface in the path of the flow of lignocellulose-containing particles, the retarding surface defining an angle with respect to the direction of flow of the lignocellulose-containing particles. Most preferably, the retarding surface includes an upper portion disposed at a first angle and a lower portion disposed at a second angle, the first angle being less than the second angle, the retarding surface having a profile in the vertical direction. In a preferred embodiment, the method includes adjusting the profile in the vertical direction of the retarding surface and adjusting the position of the retarding surface.

In accordance with one embodiment of the method of the present invention, the method includes guiding the path of movement of the flow of lignocellulose-containing particles to the forming belt.

In accordance with another embodiment of the method of the present invention, the retarding of the flow of lignocellulose-containing particles comprises first retarding the flow of lignocellulose-containing particles at a first height by deflecting the flow of lignocellulose-containing particles in a first direction, and secondly retarding the flow of lignocellulose-containing particles at a second height by deflecting the flow of lignocellulose-containing particles in a second direction, the second direction being substantially opposite to the first direction, the second height being lower than the first height.

In accordance with the present invention, apparatus has been discovered for forming a particle mat from a flow of lignocellulose-containing particles in the production of sheets of lignocellulose-containing material, the apparatus comprising supply means disposed at a first height for supplying the flow of lignocellulose-containing particles, a forming mat disposed at a second height for receiving the flow of lignocellulose-containing particles from the first height, the second height being below the first height whereby the flow of lignocellulose-containing particles falls by means of gravity from the supply means onto the forming belt along a predetermined path, and particle retarding means for retarding the flow of lignocellulose-containing particles along the predetermined path. Preferably, the particle retarding means includes at least one particle retarding surface disposed in the predetermined path of the flow of lignocellulose-containing particles, the particle retarding surface defining an angle with respect to the predetermined path. In a preferred embodiment, the at least one particle retarding surface includes an upper portion and a lower portion, the upper portion of the at least one particle retarding surface defining a first angle with respect to the predetermined path and the lower portion of the at least one particle retarding surface defining a second angle with respect to the predetermined path, the second angle being greater than the first angle. In a further embodiment, the upper and lower portions of the at least one particle retarding surface comprise a plurality of continuously increasing angles from the upper portion of the at least one particle retarding surface to the lower portion of the at least one particle retarding surface. Preferably, the at least one particle retarding surface comprises a curved profile in the vertical direction.

In accordance with one embodiment of the apparatus of the present invention, the angle is a maximum of 45°.

In accordance with another embodiment of the apparatus of the present invention, the apparatus includes first adjusting means for adjusting the profile of the at least one particle retarding surface as seen in a vertical section. In accordance with another embodiment of the apparatus of the present invention, the apparatus includes second adjusting means for adjusting the position of the at least one particle retarding surface.

In accordance with another embodiment of the apparatus of the present invention, the apparatus includes at least one guide rail disposed in the predetermined path. Preferably, the at least one guide rail extends vertically at substantially a right angle with respect to the at least one particle retarding surface. In another embodiment, the apparatus includes adjusting means for adjusting the at least one guide rail. In one embodiment, the at least one guide rail is spaced from the at least one particle retarding surface.

In accordance with another embodiment of the apparatus of the present invention, the particle retarding means comprises a first particle retarding surface disposed at a first height for adjusting the flow of lignocellulose-containing particles in a first direction, and a second particle retarding surface disposed at a second height for deflecting the flow of lignocellulose-containing particles in a second direction, the first and second particle retarding surfaces being disposed sequentially along the predetermined path, the first height being higher than the second height.

In accordance with the present invention, a method for producing sheets of lignocellulose-containing material from a flow of lignocellulose-containing particles including the method set forth above has now been discovered.

In accordance with the present invention, a plant for producing sheets of lignocellulose-containing material from a flow of lignocellulose-containing particles including the apparatus of set forth above has also been discovered.

In accordance with one embodiment of the present invention, the above and other objects are achieved by a method comprising particular measures for retarding movement of the particles during the particle feeding process.

In accordance with another embodiment of the present invention, these objects of the present invention are achieved by apparatus comprising providing the apparatus with a particle braking or retarding means that functions to retard movement of the particles during the particle feeding process.

As a result of this retardation of the particles in accordance with the present invention, the speed of the particle flow is also dampened during its fall from the particle supply source, which may be the outlet of the metering bin, to the forming belt. This either avoids or reduces uncontrolled air movements, thereby minimizing disturbances in mat forming accuracy. As a result of such improved mat forming accuracy, the spread in the properties of the produced sheet or board is reduced. This enables the mean density of the board to be reduced, which results in significant savings in raw material, glue, heating costs, etc.

According to one preferred embodiment of the present invention, retardation of the particle flow is achieved with the aid of at least one flow retarding surface located in the path of movement of the particles during particle supply, this retardation surface defining an angle with respect to the direction of particle movement towards the retardation surface.

Retardation of particle movement with the aid of retardation surfaces is an effective way of reducing the speed of the particle flow. This has a minimum effect on the pattern of movement of the particles in other respects and can be implemented very simply and thus inexpensively. Because of its simplicity, retardation of the particle flow in this way means that the retardation process can be readily dimensioned, orientated and adjusted to the desired intensity.

According to one embodiment of this flow retarding arrangement, the angle of an upper portion of the retarding surface is smaller than a corresponding angle of a lower portion of the surface.

As a result of designing the retarding surface with different angles of its different portions in this way, the different portions of the retarding surface are optimized for different sub-functions. The smaller angle of the upper portion of the surface ensures that the particle flow will not be halted as a result of the particles impinging on the surface. However, the angle is sufficient to sufficiently dampen the speed at which the particles fall. A larger angle can then be accepted at the lower portion of the surface for additional retardation, whereby the particles are caused essentially to slide along the surface and to leave the surface at a significantly reduced speed.

In this regard, it is preferred that the angle of the retarding surface increases continually from the upper portion to the lower portion thereof.

This minimizes the risk of disturbances in the flow of particles. It is particularly preferred that the retarding surface has an arcuate or curved profile in its vertical section, whereby a continuous change in angle is obtained readily and also optimally with respect to the influence exerted on the flow.

These embodiments or designs therefore constitute particularly preferred embodiments of the present invention.

According to another preferred embodiment of the present invention, the angle is at most 45°. An angle of this value at the most reduces the risk of the retarding surface halting the flow of particles.

According to another preferred embodiment of the present invention, the profile of the retarding surface in a vertical section is adjustable. This enables the influence of the retarding surface on the flow to be optimized while observing the partially conflicting influences that occur. The profile can be adjusted with respect to the particle composition concerned and with respect to other conditions in each particular case. This adjustability also enables the best retardation properties to be achieved iteratively. When the retarding surface has an arcuate or curved shape, profile adjustment involves a variation of the radius.

According to another embodiment of the present invention, the position of the retarding surface can be adjusted. This provides another possibility of influencing the process in a way to optimize same and to provide advantages similar to those described immediately above.

According to another preferred embodiment of the present invention, there is provided at least one guide rail in the path of movement of the particles falling onto the forming belt. Such guide rails enable the supply of particles to be sectioned, which further enhances the possibility of obtaining a homogenous mat. This is because the guide rails can have a further reducing influence on disturbing air currents in the transverse direction of the forming belt in certain instances, and because the guide rails increase the possibility of obtaining a uniform and smooth distribution of the particles in the transverse direction.

According to one preferred embodiment of the present invention, each guide rail is generally orientated vertically and essentially at right angles to the retarding surface. Guide rails orientated in this way will best fulfil the aforedescribed function.

According to a further preferred embodiment of the present invention, at least one guide rail is adjustable. Because the guide rails are movable, it is possible to guide the flow of particles mechanically in the transverse direction of the forming belt to some extent, thereby further increasing the possibility of adapting the method to an optimum in respect of prevailing operating conditions.

According to a further embodiment of the present invention, each guide rail is spaced from the retarding surface. This prevents particles from collecting in corners formed between guide rail and retarding surface.

According to a further preferred embodiment of the present invention, at least two retarding surfaces are placed mutually sequentially in the movement path of the particles, wherein the first surface is situated at a higher level than the second surface, and wherein the retarding surfaces are arranged so that the first surface will deflect movement of the particles in a first deflection direction and the second surface will deflect movement of the particles in the opposite deflection direction.

This arrangement of two or more mutually sequential retarding surfaces results in a stepwise reduction in the speed of the particles, so as to obtain a relatively large, but smooth, total retardation of the particles. This enhances the possibility of the particles being received by the forming belt in the absence of disturbances.

From the third and fourth aspects of the present invention, the above objects have been achieved with a method and plant for producing sheets or boards from lignocellulose-containing material comprising the particular measures set forth above, particularly with respect to the infeed of mat forming particles.

Such a method and such a plant provide the advantages described above with respect to the method of forming a particle mat.

As will be apparent from the aforegoing with respect to the background of the invention, the reference to particles is not limited solely to lignocellulose-containing particles, but also to possible admixtures of particles of some other material, such as plastic, wastepaper, fiberglass, finely divided minerals, etc. The particles may vary in size and shape and may, for instance, include fibers and/or fiber bundles.

### BRIEF DESCRIPTION OF THE DRAWINGS

The present invention may be more fully appreciated by reference to the following detailed description, which in turn refers to the drawings in which:

FIG. 1 is a side, elevational, partially sectional view of plant that illustrates the prior art.

FIG. 2 is a side, elevational, schematic illustration of the problem that the present invention is intended to overcome.

FIG. 3 is a side, elevational, schematic, sectional, enlarged view of one embodiment of the apparatus of the present invention.

FIG. 4 is a side, elevational, sectional, enlarged view of one portion of the apparatus according to another embodiment of the present invention.

FIG. 5 is a side, elevational, sectional, enlarged view of a portion of the apparatus according to another embodiment of the present invention.

### DETAILED DESCRIPTION

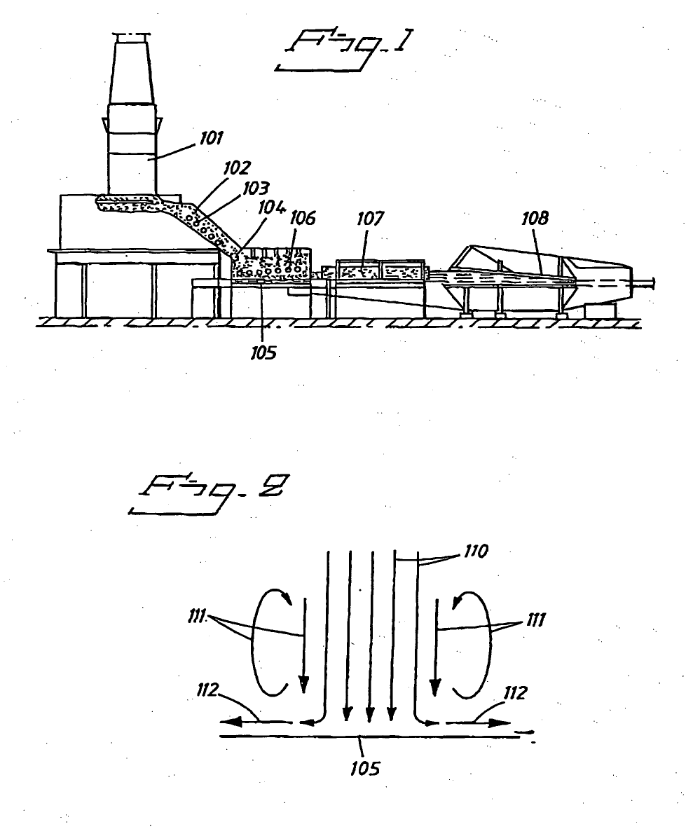

FIG. 1 illustrates a plant of the kind to which the present invention is intended to be applied. The plant includes a feeder for feeding particles onto a forming belt, THE feeder being of a conventional kind. The figure thus represents the techniques of the prior art.

The raw material, i.e. lignocellulose-containing material that has been disintegrated into particles, fibers and/or fiber bundles, is passed from a container 101 to a metering bin 102. The raw material may also contain particles of some other materials. The metering bin 102 is equipped with feed rollers 103, which feed the particulate material to a bin outlet 104. The bin outlet forms a supply source for feeding particles to a forming belt 105. This takes place by the particles simply falling down from the bin outlet 104 and onto the forming belt 105 under the force of gravity.

The forming belt 105 moves to the right as seen in the figure and the falling particles form a mat on the belt under the influence of forming rollers 106 acting above the belt. The formed mat of lignocellulose-containing particles is then transported by the belt to the right in the figure for treatment in following board-producing stages 107, 108. The plant may include treatment stages other than those shown in the figure.

The present invention is directed to the stage in which the particles are fed from the bin outlet 104 to the forming belt 105, and is related to a specific problem encountered in this stage.

This problem is illustrated more specifically in FIG. 2. Air streams form as the particles 110 drop onto the forming belt 105 at a relatively high speed. These air streams are of two kinds, consisting respectively of air entrained by ejection, as illustrated by the arrows 111, and displaced air, as illustrated by the arrows 112. The manner in which such air movements influence the distribution of the particles on the forming belt so as to cause irregularities and unevenness has been discussed above.

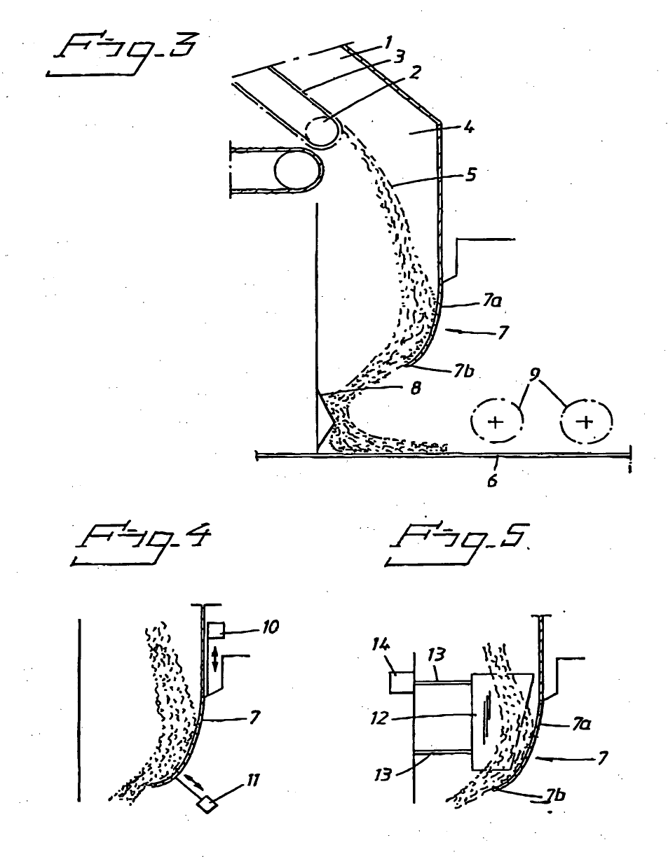

FIG. 3 is a schematic side view which illustrates how particles are fed from a metering bin to a forming belt in accordance with one advantageous embodiment of the present invention. The particles are conveyed down through the bin 1 with the aid of feed rollers 2 and a feeding belt 3 to a bin outlet 4. The outlet 4 constitutes a feed source from which particles 5 are deposited on the forming belt 6.

The particles 5 are prevented from falling directly onto the forming belt 6, by means of a number of particle retarding surfaces, 7 and 8, (two such surfaces are shown in the illustrated embodiment) disposed in the movement path of the particles. The retardation surfaces, 7 and 8, are conveniently comprised of sheet metal. The particles first flow down onto the uppermost retarding surface 7, thereby reducing the speed of the particles and deflecting the direction in which they fall. The particles then fall from the first retardation surface 7 down onto the second retardation surface 8, thereby further retarding movement of the particles. The particles then fall onto the forming belt at a relatively low speed, so that the influence of the air eddy currents will be negligible. The particles form on the forming belt, which moves to the right in the figure, a mat which is transported to subsequent treatment stages by means of forming rollers 9.

The retarding surface 7 of the illustrated embodiment has an arcuate or curved profile. The upper portion 7a of the retarding surface, i.e. the uppermost portion of the surface upon which particles impinge, deviates relatively slightly from the vertical and is designed so that its angle to the direction of particle impingement is relatively small, preferably smaller than 45°. The angle of the retarding surface to the vertical then increases continuously down to the lower portion 7b of the retarding surface. When the particles leave the lower portion 7b of the retarding surface, its angle with respect to the vertical is about 45°.

FIG. 4 illustrates an embodiment in which the first guide surface, or plate, 7 is adjustable. The position of the plate can be adjusted by moving the plate vertically by means of a maneuvering device 10. The radius of the plate 7 can be adjusted by means of a further maneuvering device 11.

FIG. 5 illustrates a further embodiment in which the apparatus has been supplemented with guide plates. Each guide plate 12 is arranged to lie in a plane parallel with the transport direction of the forming belt. The guide plate 12 of the illustrated embodiment is fitted to a wall 15 of a shaft with the aid of stays or braces 13, so as to define a space between the retarding plate 7 and the guide plate 12. The guide plates 12 divide the flow of particles into sub-flows in the transverse direction.

Each guide plate 12 can be moved laterally, i.e. up and down in relation to the plane of the figure, by means of a control device. 14.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1-21. (canceled)

22. A method of forming a particle mat from a flow of lignocellulose-containing particles in the production of sheets of lignocellulose-containing material, said method comprising providing said flow of lignocellulose-containing particles from a supply source at a predetermined height, depositing said flow of lignocellulose-containing particles from said predetermined height by means of gravity onto a forming belt at a location below said predetermined height, and retarding said flow of lignocellulose-containing particles from said predetermined height to said location below said predetermined height.

23. The method of claim 22 wherein said retarding of said flow of lignocellulose-containing particles comprises providing a retarding surface in the path of said flow of lignocellulose-containing particles, said retarding surface defining an angle with respect to the direction of flow of said lignocellulose-containing particles.

24. The method of claim 23 wherein said retarding surface includes an upper portion disposed at a first angle and a lower portion disposed at a second angle, said first angle being less than said second angle, said retarding surface having a profile in the vertical direction.

25. The method of claim 24 including adjusting said profile in the vertical direction of said retarding surface and adjusting the position of said retarding surface.

26. The method of claim 23 including guiding the path of movement of said flow of lignocellulose-containing particles to said forming belt.

27. The method of claim 23 wherein said retarding of said flow of lignocellulose-containing particles comprises first retarding said flow of lignocellulose-containing particles at a first height by deflecting said flow of lignocellulose-containing particles in a first direction, and secondly retarding said flow of lignocellulose-containing particles at a second height by deflecting said flow of lignocellulose-containing particles in a second direction, said second direction being substantially opposite to said first direction, said second height being lower than said first height.

28. Apparatus for forming a particle mat from a flow of lignocellulose-containing particles in the production of sheets of lignocellulose-containing material, said apparatus comprising supply means disposed at a first height for supplying said flow of lignocellulose-containing particles, a forming mat disposed at a second height for receiving said flow of lignocellulose-containing particles from said first height, said second height being below said first height whereby said flow of lignocellulose-containing particles falls by means of gravity from said supply means onto said forming belt along a predetermined path, and particle retarding means for retarding said flow of lignocellulose-containing particles along said predetermined path.

29. The apparatus of claim 28 wherein said particle retarding means includes at least one particle retarding surface disposed in said predetermined path of said flow of lignocellulose-containing particles, said particle retarding surface defining an angle with respect to said predetermined path.

30. The apparatus of claim 29 wherein said at least one particle retarding surface includes an upper portion and a lower portion, said upper portion of said at least one particle retarding surface defining a first angle with respect to said predetermined path and said lower portion of said at least one particle retarding surface defining a second angle with respect to said predetermined path, said second angle being greater than said first angle.

31. The apparatus of claim 30 wherein said upper and lower portions of said at least one particle retarding surface comprise a plurality of continuously increasing angles from said upper portion of said at least one particle retarding surface to said lower portion of said at least one particle retarding surface.

32. The apparatus of claim 31 wherein said at least one particle retarding surface comprises a curved profile in the vertical direction.

33. The apparatus of claim 29 wherein said angle is a maximum of 45°.

34. The apparatus of claim 29 including first adjusting means for adjusting the profile of said at least one particle retarding surface as seen in a vertical section.

35. The apparatus of claim 29 including second adjusting means for adjusting the position of said at least one particle retarding surface.

36. The apparatus of claim 29 including at least one guide rail disposed in said predetermined path.

37. The apparatus of claim 36 wherein said at least one guide rail extends vertically at substantially a right angle with respect to said at least one particle retarding surface.

38. The apparatus of claim 36 including adjusting means for adjusting said at least one guide rail.

39. The apparatus of claim 36 wherein said at least one guide rail is spaced from said at least one particle retarding surface.

40. The apparatus of claim 28 wherein said particle retarding means comprises a first particle retarding surface disposed at a first height for adjusting said flow of lignocellulose-containing particles in a first direction, and a second particle retarding surface disposed at a second height for deflecting said flow of lignocellulose-containing particles in a second direction, said first and second particle retarding surfaces being disposed sequentially along said predetermined path, said first height being higher than said second height.

41. A method for producing sheets of lignocellulose-containing material from a flow of lignocellulose-containing particles including the method of claim 22.

42. A plant for producing sheets of lignocellulose-containing material from a flow of lignocellulose-containing particles including the apparatus of claim 28.
